(19) United States
(12) Patent Application Publication
(10) Pub. No.: US 2011/0181182 A1
(43) Pub. Date: Jul. 28, 2011

(54) TOP VIEW LIGHT EMITTING DEVICE PACKAGE AND FABRICATION METHOD THEREOF

(75) Inventors: MIN-TSUN HSIEH, Hukou (TW); WEN-LIANG TSENG, Hukou (TW); LUNG-HSIN CHEN, Hukou (TW); CHIH-YUNG LIN, Hukou (TW)

(73) Assignee: ADVANCED OPTOELECTRONIC TECHNOLOGY, INC., Hsinchu Hsien (TW)

(21) Appl. No.: 12/915,072

(22) Filed: Oct. 29, 2010

(30) Foreign Application Priority Data
Jan. 28, 2010 (TW) 99102381

(51) Int. Cl. H01J 7/44; H01J 9/00

(52) U.S. Cl. 315/32; 445/23

(57) ABSTRACT

A top view light emitting device package and fabrication method thereof include a bilateral circuit is provided for emitting two far light fields with no requirement for multiple devices. Moreover, the top view light emitting device package of the disclosure also provides depressions and reflectors formed on the surfaces of the silicon substrate to enhance the reflective efficiency and fix a specific light field.

### BACKGROUND

1. Technical Field

The disclosure relates generally to semiconductor package technology, and more particularly to a top view light emitting device package.

2. Description of the Related Art

With progress in semiconductor light emitting device development, light emitting diodes (LED), organic light emitting diodes (OLED), or laser diodes (LD) are becoming increasingly popular, due to longer lifetime, lower power consumption, less heat generation, and compact size. Generally, the semiconductor light emitting devices are surface mounted devices (SMD) for providing all kinds of industry. The semiconductor light emitting devices dissipate heat via constructions of polyphthalamide (PPA), polypropylene (PP), polycarbonate (PC) or polymethylmethacrylate (PMMA). These materials have low thermal conductivity between 0.1 and 0.22 W/M-k and reduce lifetime of the devices. Hence, high thermal conductivity materials, such as silicon or ceramic, are progressively used for replacing conversional material.

In modern products, requirements for high luminance and minimal profile are necessary. However, conventional semiconductor package has only one single emitting surface. If a single device with multiple emitting surfaces is required for lighting or backlight, it may be achieved by integrating numerous devices which increases both cost and volume. What is needed, therefore, is a single semiconductor package with multiple emitting surfaces which can overcome the described limitations.

### BRIEF DESCRIPTION OF THE DRAWINGS

FIG. 1A is a top view of a top view light emitting device package in accordance with a first embodiment of the disclosure.

FIG. 1B is a bottom view of the top view light emitting device package in accordance with the first embodiment of the disclosure.

FIG. 1C is a cross section taken along line III-III of FIG. 1A.

FIG. 2A is a top view of a top view light emitting device package in accordance with a second embodiment of the disclosure.

FIG. 2B is a bottom view of the top view light emitting device package in accordance with the second embodiment of the disclosure.

FIG. 2C is a cross section taken along line VI-VI of FIG. 2A.

FIG. 3 is a cross section of a top view light emitting device package in accordance with a third embodiment of the disclosure.

FIG. 4 is a cross section of a top view light emitting device package in accordance with a fourth embodiment of the disclosure.

FIG. 5 is a cross section of a top view light emitting device package in accordance with a fifth embodiment of the disclosure.

FIG. 6 is a flowchart illustrating a process for fabricating a top view light emitting device package of the disclosure.

### DETAILED DESCRIPTION

Exemplary embodiments of the disclosure will now be described with reference to the accompanying drawings.

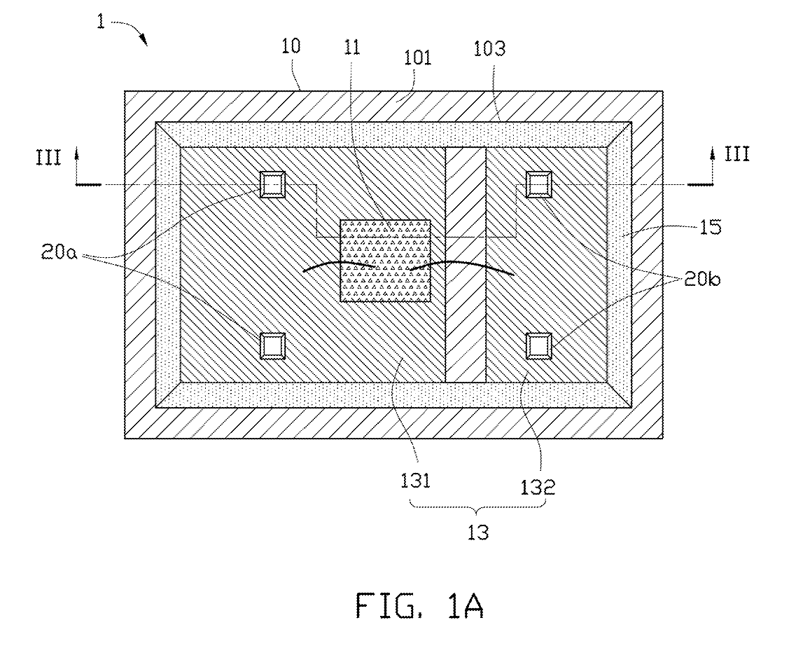

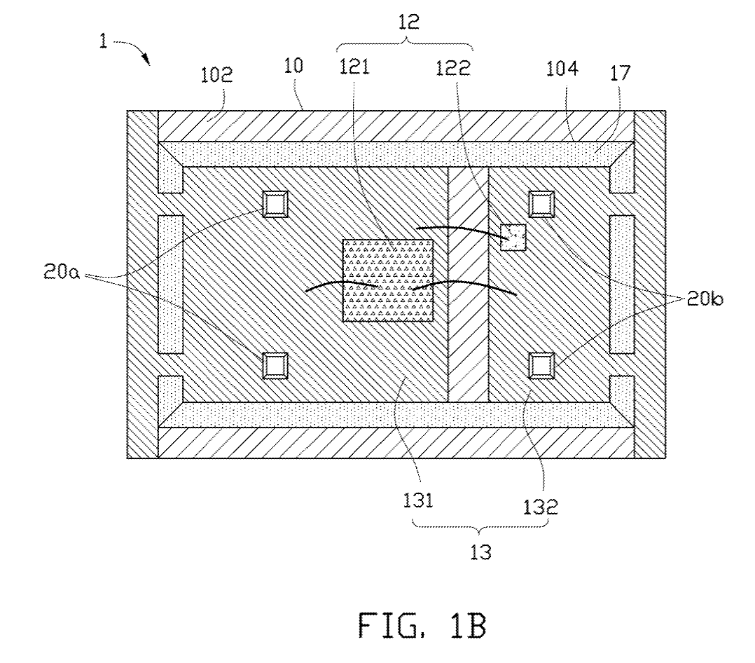

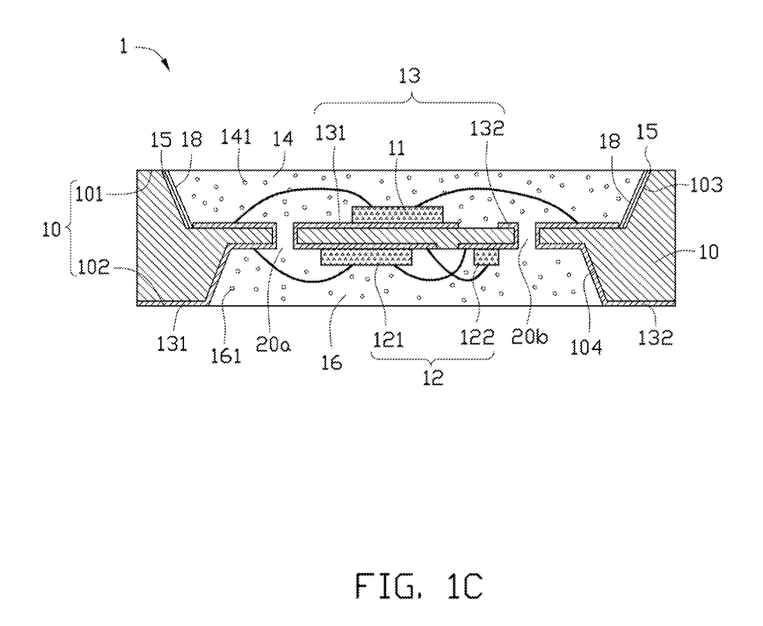

The disclosure provides a first embodiment of a top view light emitting device package 1, as shown in FIG. 1A, FIG. 1B and FIG. 1C, comprising a silicon substrate 10, a first semiconductor device 11, at least one second semiconductor device 12 and an electric circuit 13. The silicon substrate 10 comprises a first surface 101 and a second surface 102, respectively allocated on opposite sides of the silicon substrate 10, wherein the first surface 101 is a light emitting surface and the second surface 102 is a base for the top view light emitting device package 1.

To accommodate the light field of the top view light emitting device package 1, a first depression 103 is allocated upon the first surface 101, with the first semiconductor device 11 disposed therein. Similarly, a second depression 104 is allocated upon the second surface 102 of the silicon substrate 10, with the at least one second semiconductor device 12 disposed therein.

To enhance light emitting efficiency of the top view light emitting device package 1, a first reflector 15 is formed on the inner surface of the first depression 103 and a second reflector 17 is formed on the inner surface of the second depression 104. Accordingly, the first reflector 15 and the second reflector 17 are metal, such as aluminum, silver, gold or tin, that is able to enhance light extraction from the first semiconductor device 11 and the at least one second semiconductor device 12. Moreover, a first insulator 18 covers the first reflector 15 to prevent electrical connection of the first reflector 15 and the electric circuit 13. Similarly, a second insulator (not shown) covers the second reflector 17 to prevent electrical connection of the second reflector 17 and the electric circuit 13. Accordingly, the first insulator 18 and the second insulator can be transparent and insulated materials such as silicon oxide or silicon nitride.

The electric circuit 13 is formed on the first and second surfaces 101, 102, and electrically connects the first semiconductor device 11 and the at least one second semiconductor device 12 to an external circuit (not shown). Specifically, the electric circuit 13 is formed on the first surface 101 and extends to the second surface 102 via a plurality of through holes 20a, 20b passing through the silicon substrate 10 from the first surface 101 to the second surface 102. In the disclosure, the plurality of through holes 20a, 20b passes through the first depression 103 to the second depression 104, as shown in FIG. 1C, although disclosure is not limited thereto and it can have any structure sufficient to the same purpose. Alternatively, the electric circuit 13 can fully fill or not fill the plurality of through holes 20a, 20b. Moreover, the electric circuit 13 comprises a first electrode 131 and a second electrode 132 electrically disconnecting each other, wherein both the first electrode 131 and the second electrode 132 extend from the first surface 101 to the second surface 102. The first semiconductor device 11 and the at least one second semiconductor device 12, respectively, electrically connect to the first electrode 131 and the second electrode 132 by wire bonding or flip-chip. Specifically, the electric circuit 13 is metal such as copper, nickel, silver, aluminum, tin, gold or alloy thereof. That is, the electric circuit 13 not only can electrically connect the top view light emitting device package 1 to the external circuit, but can redirect the light generated from the semiconductor device to a desired direction.

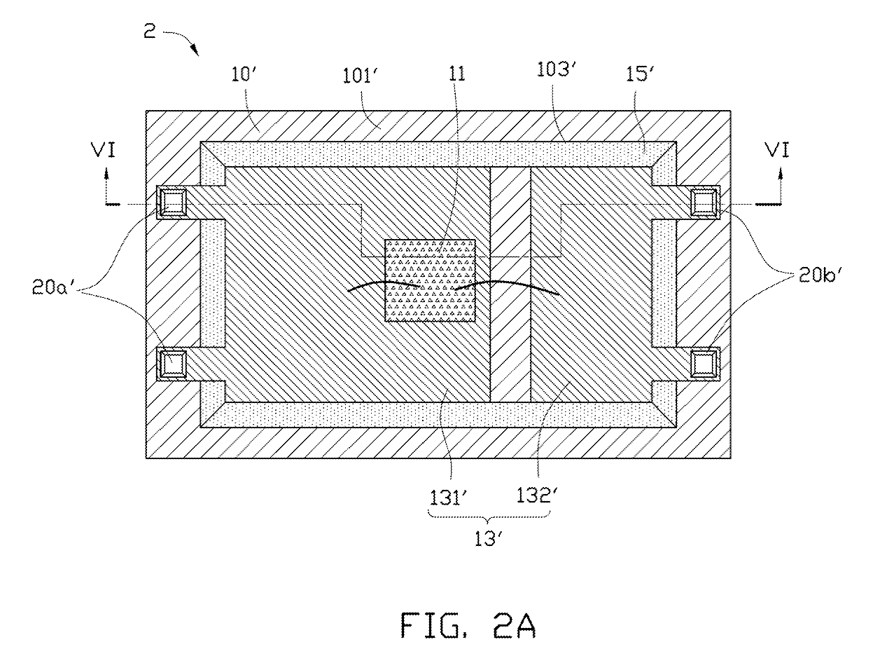

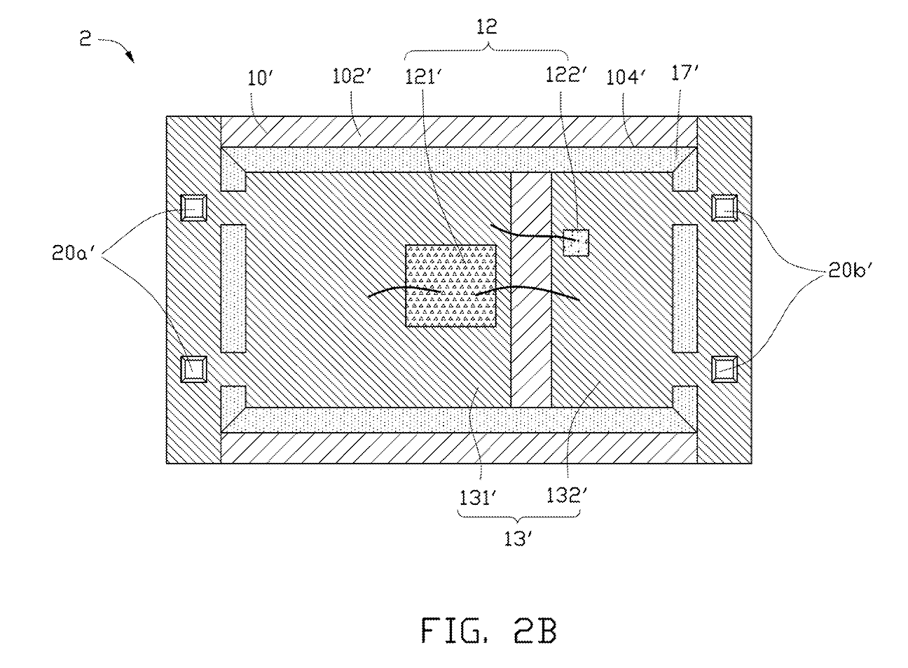

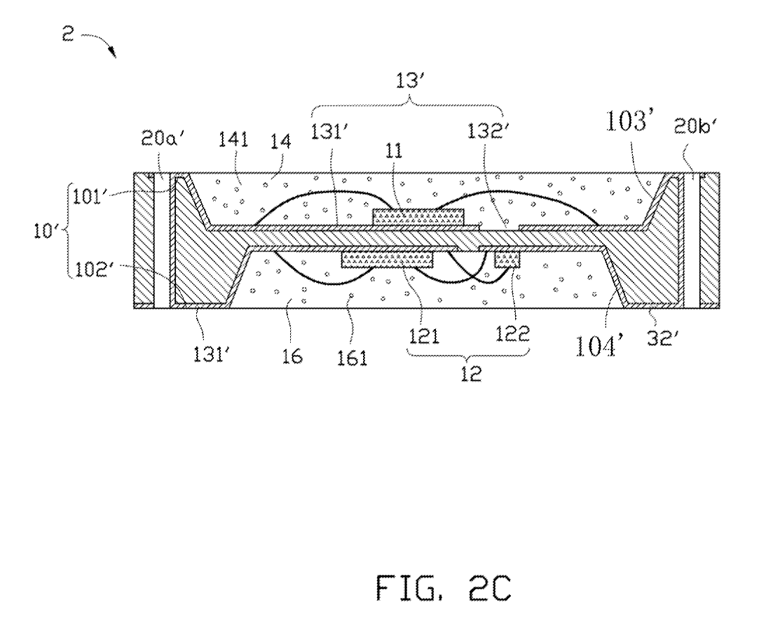

The disclosure also provides a second embodiment of a top view light emitting device package 2, as shown in FIG. 2A, FIG. 2B and FIG. 2C, differing from the first embodiment only in the presence of a plurality of through holes 20a′, 20b′ passing through the first surface 101′ to the second surface 102′ outside the first and the second depressions 103′, 104′. Moreover, an electric circuit 13′ comprises a first electrode 131′ and a second electrode 132′, extending from the first depression 103′ to the second depression 104′ via the plurality of through holes 20a′, 20b′ outside the first and the second depression 103′, 104′.

Referring to FIG. 1A, FIG. 1C, FIG. 2A and FIG. 2C, the first semiconductor device 11 is disposed on the first surface 101, 101′ inside the first depression 103, 103′. The first semiconductor device 11 is a light emitting diode, laser diode or any semiconductor light emitting device capable of emitting light of at least one wavelength. Accordingly, the first semiconductor device 11 can be III-V or II-VI compound semiconductor, able to emit visible or invisible light such as ultraviolet, blue, green or multiple wavelengths. Alternatively, the first semiconductor device 11 also can include multiple devices to emit at least two varied wavelengths.

Referring to FIG. 1B, FIG. 1C, FIGS. 2B and 2C, the at least one second semiconductor device 12 is disposed on the second surface 102, 102′ inside the second depression 104, 104′. In the disclosure, the at least one second semiconductor device 12 comprises a second semiconductor light emitting device 121 and a Zener diode 122. Similarly, the second semiconductor light emitting device 121 is similar to the first semiconductor device 11 as described.

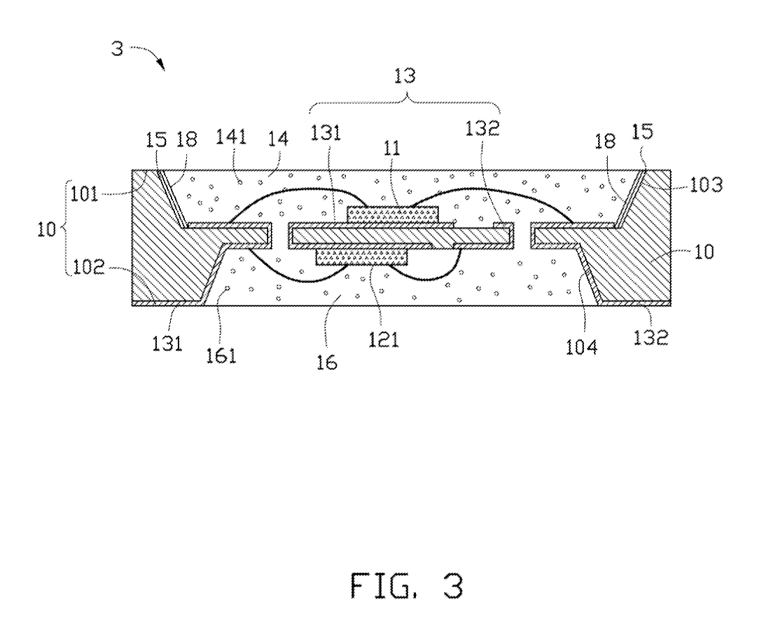

In the disclosure, the top view light emitting device package is a semiconductor light emitting device with two light emitting surfaces, as shown in FIG. 1C, FIG. 2C and FIG. 3. In the top view light emitting device packages 1, 2 in accordance with the first and second embodiments, the at least one second semiconductor device 12 further comprises a Zener diode 122 configured for preventing damage from electrostatic or pulse. Alternatively, a top view light emitting device package 3 accordance with a third embodiment of the disclosure comprises the first semiconductor device 11 and the second semiconductor light emitting device 121 respectively formed on opposite sides of the silicon substrate 10.

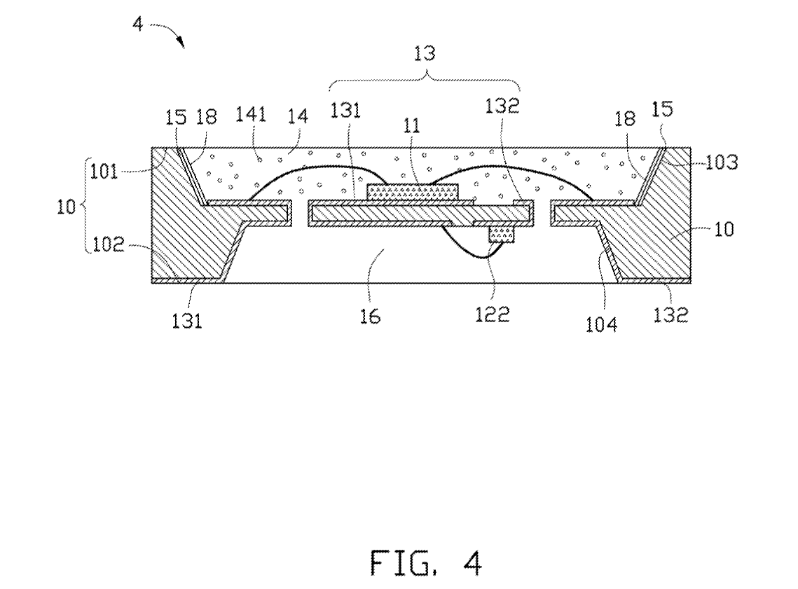

A top view light emitting device package 4 in accordance with a fourth embodiment of the disclosure is shown in FIG. 4, including a semiconductor light emitting device with a single light emitting surface. Specifically, the Zener diode 122 is disposed on the side opposite to the first semiconductor device 11 configured for preventing luminous absorption from the Zener diode 122.

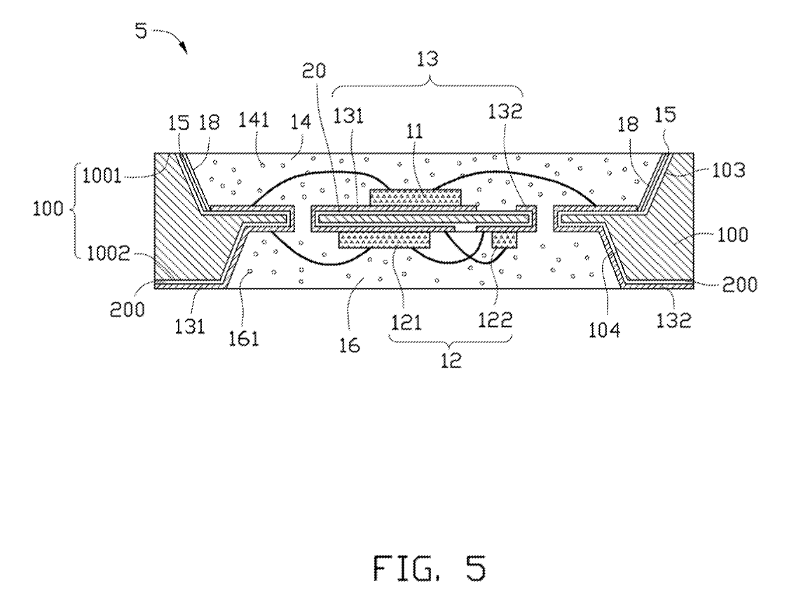

According to the description, the silicon substrates 10, 10′ are high resistance and electrically non-conductive. Alternatively, in a fifth embodiment of the disclosure, the silicon substrate 100 is low resistance and electrically conductive. As shown in FIG. 5, the top view light emitting device package 5 comprises a third insulator 200 allocated between the electric circuit 13 and the silicon substrate 100. In the disclosure, the third insulator 200 is non-conductive material such as silicon oxide or silicon nitride. By applying the third insulator 200 upon the silicon substrate 100, the electric circuit 13 and the silicon substrate 100 are insulated such that electric current within the electric circuit 13 leaking into the silicon substrate 100 is prevented.

Referring to FIG. 1C, FIG. 2C, FIG. 3, FIG. 4 and FIG. 5, the top view light emitting device packages 1, 2, 3, 4, 5 also comprise a first cover layer 14 allocated inside the first depression 103, 103′, wherein the first cover layer 14 encapsulates the first semiconductor device 11 and a portion of the electric circuit 13, 13′. The first cover layer 14 can be silicone, epoxy, or any transparent material. In the disclosure, the first cover layer 14 comprises at least one first luminescent conversion element 141 such as YAG, TAG, silicate, nitride, nitrogen oxides, phosphide, sulfide or combination thereof. When the at least one first luminescent conversion element 141 is excited by light emitted from the first semiconductor device 11, thereafter, converted light is emitted from the at least one luminescent conversion element 141 to mix with other light from the first semiconductor device 11 for obtaining white light. Similarly, the top view light emitting device packages 1, 2, 3, 4, 5 also comprise a second cover layer 16 allocated inside the second depression 104, 104′, wherein the second cover layer 16 encapsulates the at least one second semiconductor device 12 and a portion of the electric circuit 13, 13′. The second cover layer 16 is similar to the first cover layer 14 as described. Moreover, in the top view light emitting device packages 1, 2, 3, 5, the second cover layer 16 comprises at least one second luminescent conversion element 161 such as the at least one first luminescent conversion element 141. When the at least one second luminescent conversion element 161 is excited by light emitted from the second semiconductor device 121, thereafter, converted light is emitted from the at least one second luminescent conversion element 161 to mix with other light from the second semiconductor device 121 to obtain white light.

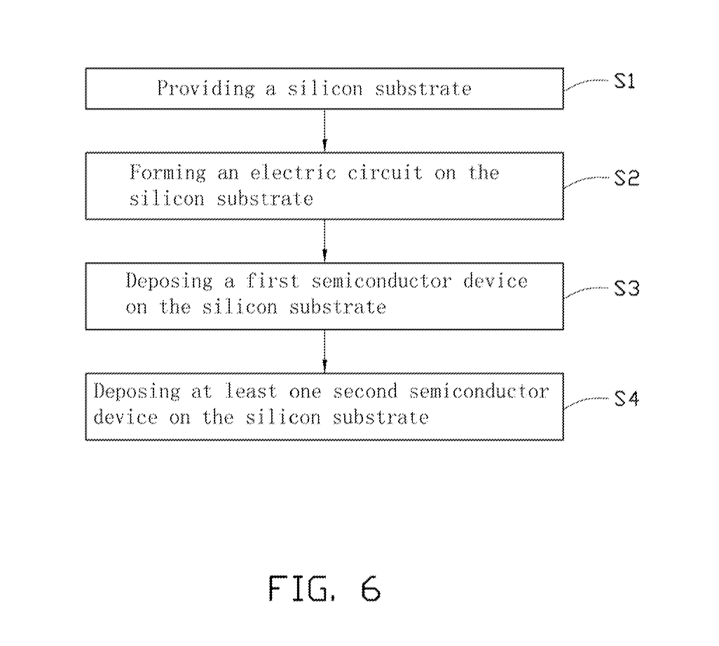

As shown in FIG. 6, a manufacturing method of the top view light emitting device package according to the disclosure is undertaken as follows.

In step S1, a silicon substrate is provided, wherein the silicon substrate comprises a first surface and a second surface, respectively allocated on the opposite sides of the silicon substrate.

In step S2, an electric circuit is formed on the silicon substrate by electric plating, evaporation or E-gun evaporation.

In step S3, a first semiconductor device is disposed on the first surface and electrically connecting to the electric circuit. In the disclosure, the first semiconductor device electrically connects to the electric circuit by conductive wire. Alternatively, the first semiconductor device can electrically connect to the electric circuit by flip-chip.

In step S4, at least one second semiconductor device is disposed on the second surface and electrically connects to the electric circuit. Similarly, the least one second semiconductor device may electrically connect to the electric circuit by conductive wire or flip-chip. Alternatively, the at least one second semiconductor device can comprise a semiconductor light emitting device, Zener diode or hybrid thereof.

In the disclosure, a first depression is allocated upon the first surface and the first semiconductor device is disposed inside the first depression. A second depression is allocated upon the second surface and the at least one second semiconductor device is disposed inside the second depression. More particularly, the first depression and the second depression can be formed by wet-etching.

In the disclosure, a first reflector and a second reflector are respectively formed on the first surface and second surface. The first reflector and the second reflector are metal, which is made by electroplating, sputtering or molecular beam evaporation (MBE). Moreover, a first insulator is formed on the first reflector and a second insulator is formed on the second reflector. The first and second insulators may be silicon oxide or silicon nitride, formed by oxidation or nitriding.

The silicon substrate may be low resistance or high resistance alternatively. While the silicon substrate is low resistance and electrically conductive, a third insulator is allocated between the electric circuit and the silicon substrate. Similarly, the third insulator can be the same material and manufacturing method as the first and second insulators.

In the silicon substrate, a plurality of through holes passing through the first surface to the second surface is formed, by, for example, wet-etching. A first electrode and a second electrode electrically disconnecting from each other are formed, wherein the first electrode and the second electrode can be separated by etching.

According to the disclosure, the top view light emitting device package is principally composed of silicon and metal that can enhance thermal-dissipating efficiency, increase light efficiency and lifetime of the device. Additionally, the top view light emitting device package of the disclosure provides bilateral electrical circuitry for emitting two far light fields with no requirement for multiple devices. Moreover, the top view light emitting device package of the disclosure also provides depressions and reflectors formed on the surfaces of the silicon substrate to enhance the reflective efficiency and fix a specific light field.

It is to be understood, however, that even though numerous characteristics and advantages of the disclosure have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A top view light emitting device package, comprising:
a silicon substrate, comprising a first surface and a second surface, wherein the first surface and the second surface are formed on opposite sides of the silicon substrate;
an electric circuit, formed on the first surface and the second surface of the silicon substrate;
a first semiconductor device, allocated on the first surface and electrically connecting to the electric circuit, wherein the first semiconductor device is capable of emitting light with at least one wavelength; and
at least one second semiconductor device, allocated on the second surface of the silicon substrate and electrically connect to the electric circuit;
wherein the first surface is a light emitting surface for the top view light emitting device package, and the second surface is a base electrically connecting the top view light emitting device package to an external circuit.

2. The top view light emitting device package as claimed in claim 1, wherein the first semiconductor device and the at least one second semiconductor device are light emitting diode, laser diode, Zener diode or combination thereof.

3. The top view light emitting device package as claimed in claim 1, the silicon substrate further comprising a first depression allocated upon the first surface, and a second depression allocated upon the second surface, wherein the first semiconductor device is allocated inside the first depression and the at least one second semiconductor device is allocated inside the second depression.

4. The top view light emitting device package as claimed in claim 3, the silicon substrate further comprising a first reflector formed on the inner surface of the first depression, and a second reflector formed on the inner surface of the second depression.

5. The top view light emitting device package as claimed in claim 4, the silicon substrate further comprising a first insulator covering the first reflector, and a second insulator covering the second reflector.

6. The top view light emitting device package as claimed in claim 1, wherein the silicon substrate is electrically conductive.

7. The top view light emitting device package as claimed in claim 6, further comprising a third insulator allocated between the electric circuit and the silicon substrate.

8. The top view light emitting device package as claimed in claim 1, the first surface comprises a plurality of through holes through the silicon substrate to the second surface, wherein the electric circuit extends from the first surface to the second surface via the plurality of through holes.

9. A top view light emitting device package, comprising:
a silicon substrate, comprising a first depression and a second depression respectively allocated upon bilateral sides of the silicon substrate;
a first semiconductor light emitting device and a second semiconductor light emitting device, respectively allocated inside the first and the second depressions, wherein both of the first and second semiconductor light emitting devices are respectively capable of emitting light with at least one wavelength; and
an electric circuit, formed on the silicon substrate, electrically connecting to the first and second semiconductor light emitting devices.

10. The top view light emitting device package as claimed in claim 9, further comprising a Zener diode allocated inside the second depression.

11. The top view light emitting device package as claimed in claim 9, the silicon substrate further comprising a first reflector formed on the inner surface of the first depression, and a second reflector formed on the inner surface of the second depression.

12. The top view light emitting device package as claimed in claim 11, the silicon substrate further comprising a first insulator covering the first reflector, and a second insulator covering the second reflector.

13. The top view light emitting device package as claimed in claim 9, wherein the silicon substrate is electrically-conductive.

14. The top view light emitting device package as claimed in claim 13, the silicon substrate further comprising a third insulator between the electric circuit and the silicon substrate.

15. The top view light emitting device package as claimed in claim 9, wherein the first depression comprises a plurality of through holes through the silicon substrate to the second depression, and the electric circuit extends from the first depression to the second depression via the plurality of through holes.

16. A fabrication method of a top view light emitting device package, comprising following steps:
providing a substrate with a first surface and a second surface respectively allocated on bilateral sides of the substrate;
forming an electric circuit on the first surface and the second surface;
deposing a first semiconductor device on the first surface and electrically connecting to the electric circuit, wherein the first semiconductor device is capable of emitting light with at least one wavelength; and
deposing at least one second semiconductor device on the second surface and electrically connecting to the electric circuit.

17. The fabrication method of a top view light emitting device package as claimed in claim 16, further comprising:
forming a first depression and a second depression respectively on the first and the second surface by wet-etching;
forming a first reflector on the inner surface of the first depression and a second reflector on the inner surface of the second depression by electroplating, sputtering or molecular beam evaporation (MBE); and
forming a first insulator on the first reflector and a second insulator on the second reflector by oxidation process or nitriding process.

18. The fabrication method of a top view light emitting device package as claimed in claim 16, wherein the substrate is electrically-conductive.

19. The fabrication method of a top view light emitting device package as claimed in claim 18, further comprising forming a third insulator between the electric circuit and the substrate, wherein the third insulator is silicon oxide or silicon nitride formed by oxidation process or nitriding process.

20. The fabrication method of a top view light emitting device package as in claim 16, further comprising forming a plurality of through holes through the silicon substrate from the first surface to the second surface by wet-etching.
